(19) United States
(12) Patent Application Publication
(10) Pub. No.: US 2004/0228981 A1
(43) Pub. Date: Nov. 18, 2004

(54) Method for manufacturing electrophoretic display

(75) Inventors: Chi-Chang Liao, Hsinchu (TW); Kang-Hung Liu, Hsinchu (TW); Ing-Jer Lin, Hsinchu (TW); Yi-Chun Wong, Hsinchu (TW); Chia-Rong Sheu, Hsinchu (TW)

Correspondence Address: BACON & THOMAS, PLLC, 625 SLATERS LANE, FOURTH FLOOR, ALEXANDRIA, VA, 22314

(73) Assignee: Industrial Technology Research Institute, Hsinchu (TW)

(21) Appl. No.: 10/653,989

(22) Filed: Sep. 4, 2003

(30) Foreign Application Priority Data
May 13, 2003 (TW) 092112916

(51) Int. Cl. B05D 5/06

(52) U.S. Cl. 427/558; 427/64

(57) ABSTRACT

The present invention discloses a method for manufacturing an electrophoretic display. The major feature is wrapping the colored and charged particles with photo polymeric material so as to enable an electrophoretic display. The manufacturing process includes steps as proceeding to a polymerization manufacturing process where an assist substrate having a buffer layer is coated with a first layer of photo polymeric material. The first layer of photo polymeric material then undergoes required steps such as conductive layer electrode fabricating. The second layer of photo polymeric material mixture is coated on a substrate having a plurality of electrode patterns. The assist substrate is aligned with the substrate. Then a mask exposure polymerization manufacturing process is performed so as to combining the assist substrate and the substrate and separate the charged particles solution from the polymeric material. The assist substrate is removed from the substrate and the manufacturing process is completed.

### FIELD OF THE INVENTION

A present invention relates to a manufacturing process for an electrophoretic display. The present invention is featured with less product thickness and weight. The present invention is particularly applicable in flexible plastic substrate and featured with providing less manufacturing process steps, easier control over parameters and delivering more diversified display modes of an electrophoretic display.

### BACKGROUND OF THE INVENTION

As the personal digital communication devices become popular, portable display panel evolves from the 7 sets numeral display by earlier time, to the color multimedia display at the present. It is perceived that the display devise plays an important role in the personal digital communication products. Display devices applied in the portable digital products are required to meet several requirements such as color display, low power consumption and compact size. In addition, it is expected to be flexible in the future. For enabling a flexible nature of the display devices, a display plastic made by a single substrate manufacturing process is considered as an ideal application to fulfill aforementioned requirements. Royal Philips Electronics suggested a method of phase separated composite organic film (PSCOF) for accomplishing such display device. PSCOF employs steps having the liquid crystal molecules wrapped between photo polymeric material and a plastic substrate for forming a flexible single substrate liquid crystal display. The other important development is a microcapsule electrophoretic display method suggested by E Ink Corporation. The microcapsule electrophoretic display method unitizes electrophoresis of colored and charged particles in alternating electric filed for enabling a display. The present invention is applicable in manufacturing an electrophoretic display. Alternatively, the method is applicable in manufacturing a non substrate electrophoretic display. The WIPO patent application titled “Method for Manufacturing Liquid Crystal Thin Film Display” No. WO02/42832A2 is filed by Royal Philips Electronics. The main concept disclosed in the patent application is about wrapping liquid crystal on the substrate with polymeric material. The main manufacturing process is disclosed as shown in the FIG. 1A to 1E. First of all, In the FIG. 1A, a layer of photo polymeric material mixture 2 is coated on the substrate 1. The photo polymeric material mixture 2 is comprised of NOA 65 and liquid crystal material. A knife 3 is employed for leveling the photo polymeric material mixture 2 in the FIG. 1B. IT followed that a mask 4 is placed on top of the photo polymeric material mixture 2 and exposed by ultra violet 5. The portion of the photo polymeric material mixture 2 exposed by ultra violet 5 becomes a plurality of polymer wall rods 20. A second exposure step is completed as shown in the FIG. 1E. Ultra violet 6 having less strength is provided for a longer exposure, so as to enable surface of the photo polymeric material mixture becomes a thin hardening layer 21. At the same time, the liquid crystal is separated from the photo polymeric material.

The patent application filed by the Royal Philips Electronics requires two exposures for forming polymeric structure wrapping liquid crystals. Moreover, the second exposure requires longer processing time and lower energy than the first exposure, which may damage quality of liquid crystals. In addition, the manufacturing window is small, the yield rate is limited and the applicable options for display modes are also restricted.

Due to the fact that the unstable nature of control over manufacturing process parameters and display characteristics of a liquid crystal display, the present invention provides a improved method for manufacturing an electrophoretic display, which has advantages such as simplifying the manufacturing process, providing higher yield rate and diversified display modes.

### SUMMARY OF THE INVENTION

The present invention provides a method for manufacturing an electrophoretic display. The major feature of the present invention is about proceeding to a polymerization manufacturing process where an assist substrate having a buffer layer is coated with a first layer of photo polymeric material. The first layer of photo polymeric material then undergoes required steps of the manufacturing process for an electrophoretic display such as conductive layer fabricating. The second layer of photo polymeric material mixture is coated on a substrate having a plurality of pixel electrodes, which is required in the manufacturing process for an electrophoretic display. The assist substrate is aligned with the substrate, where the first and the second photo polymeric material are disposed between the assist substrate and the substrate. Then a mask exposure polymerization manufacturing process is performed so as to combining the assist substrate and the substrate and separate the colored and charged particles solution from the polymeric material. Lastly, the assist substrate is removed from the substrate and the manufacturing process for a single substrate electrophoretic display is completed.

The invention can be more fully understood by reading the following detailed description of the preferred embodiments, with reference made to the accompanying drawings.

### BRIEF DESCRIPTION OF THE DRAWINGS

FIG. 1A to 1E are schematic views showing prior art manufacturing process for single substrate liquid crystal display;

FIG. 2A to 2J are schematic views showing manufacturing process for a single substrate electrophoretic display according to the first embodiment of the present invention;

FIG. 3A to 3J are schematic views showing manufacturing process for a single substrate electrophoretic display according to the second embodiment of the present invention;

FIG. 4A to 4L are schematic views showing manufacturing process for a non substrate electrophoretic display according to the third embodiment of the present invention; and

FIG. 5A to 5L are schematic views showing manufacturing process for a non substrate electrophoretic display according to the fourth embodiment of the present invention.

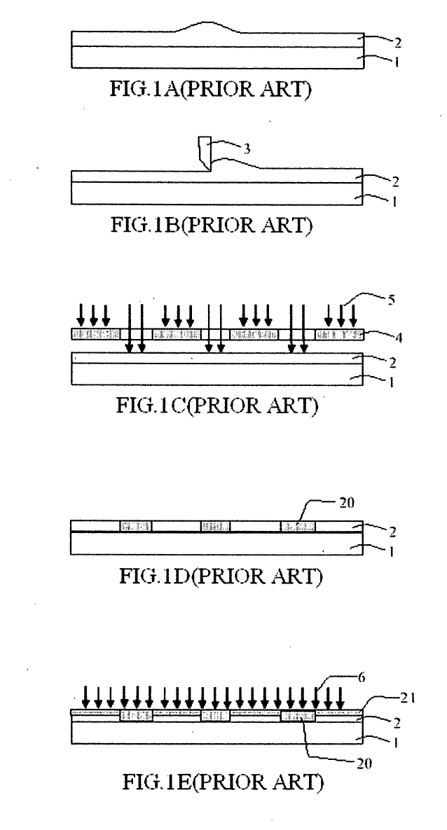

### DETAILED DESCRIPTION OF THE PREFERRED EMBODIMENTS

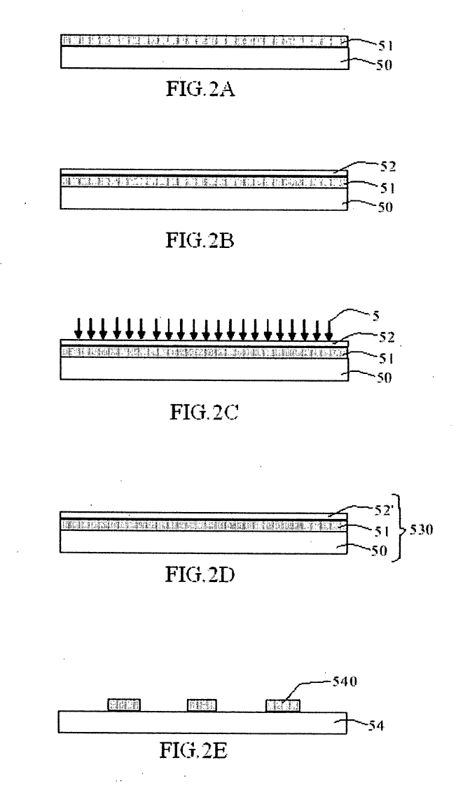

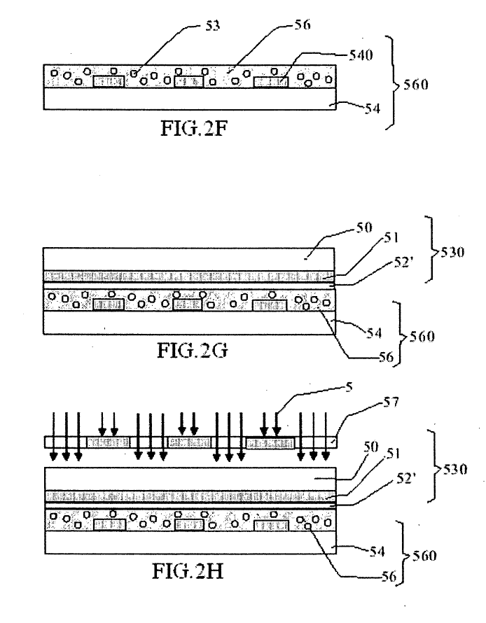

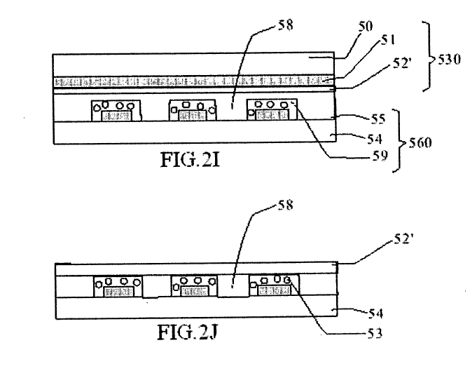

FIG. 2A to 2J are schematic views showing manufacturing process for a single substrate electrophoretic display according to the first embodiment of the present invention. The manufacturing process comprises following steps.

FIG. 2A to 2D are schematic flow charts showing manufacturing process for a first substrate. In the FIG. 2A, a buffer layer 51 is fabricated on a substrate 50. In the FIG. 2B, a photo polymeric material layer 52 (photo polymeric material such as NOA65, NOA72) is fabricated on the buffer layer 51. Then, an ultra violet 5 exposure process step is completed in the FIG. 2C. In the FIG. 2D, ultra violet 5 has the photo polymeric material 52 hardened to be the polymeric material 52′ and finishes the manufacturing process for the first substrate 530.

FIG. 2E to 2F are schematic flow charts showing a process of manufacturing a first substrate. In the FIG. 2E, an electrode pattern 540 is fabricated on a substrate 54. In the FIG. 2F, a photo polymeric material mixture 56 is coated on the substrate 54 and the electrode pattern 540. The photo polymeric material mixture 56 is a solution comprised of colored and charged particles 53. The manufacturing process for the second substrate 560 is illustrated in the following.

A step of manufacturing process for combining the first substrate 530 and the second substrate 560 is illustrated in the FIG. 2G to FIG. 2J. Firstly, the first substrate 530 is placed in a reverse positioned on top of the second substrate 560 as shown in FIG. 2G. In the FIG. 2H, a mask 57 is disposed on top of the first substrate 530 for enabling an ultra violet 5 exposure step. In the FIG. 21, a plurality of polymer walls 58 is formed from combining the first substrate 530 and the second substrate 560 after the ultra violet 5 exposure. Then, the colored and charged particles are separated from the photo polymeric material. As a result, the polymeric material wraps the charged particles. The solution comprised of photo polymeric material and colored and charged particles 53 undergoes a phase separating process and forms a purified solvent 59. In the FIG. 2J, the first substrate 530 and the second substrate 560 are removed from the assist substrate 50 and the buffer layer 51. Then the manufacturing process for a single substrate electrophoretic display according to the first embodiment of the present invention is completed.

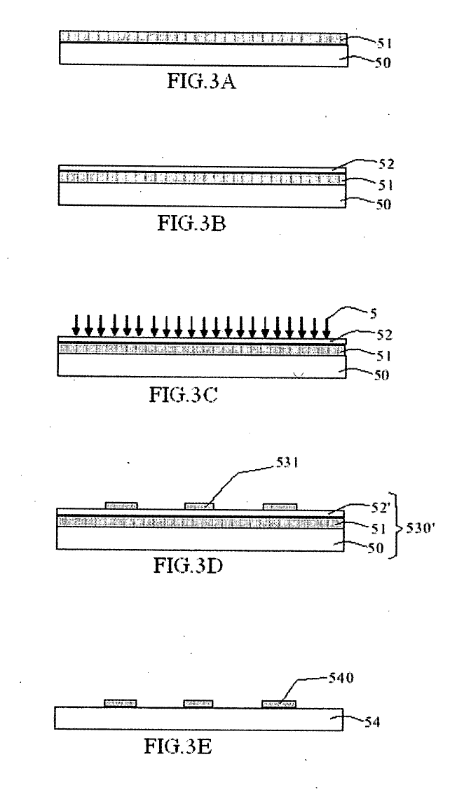

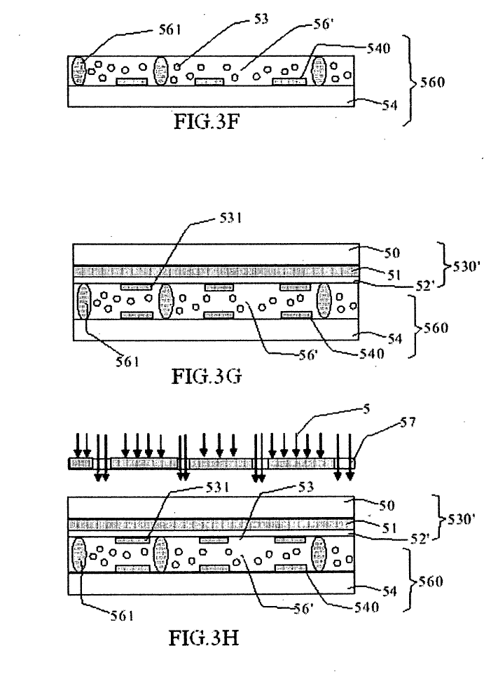

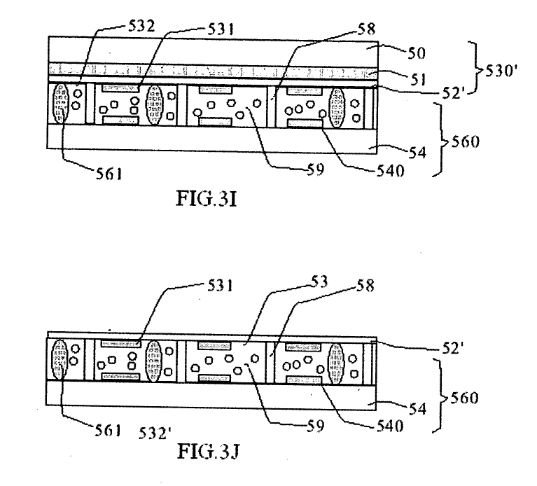

FIG. 3A to 3K are schematic views showing manufacturing process for an electrophoretic display according to the second embodiment of the present invention. The manufacturing process for the second embodiment is similar to the manufacturing process for the first embodiment. The difference lies in that the first substrate has electrode and the photo polymeric material mixture is comprised of colored and charged particles and spacer in the second embodiment. The manufacturing process for the second embodiment comprises following steps.

FIG. 3A to 3D are schematic flow charts showing a process of manufacturing a first substrate 530′. In the FIG. 3A, a buffer layer 51 is fabricated on a substrate 50. In the FIG. 2B, a photo polymeric material layer 52 (photo polymeric material such as NOA65, NOA72) is fabricated on the buffer layer 51. Then, an ultra violet 5 exposure manufacturing process step is completed in the FIG. 2C for having the photo polymeric material 52 hardened so as to form a polymeric material 52′. Electrodes 531 are fabricated on the polymeric material layer 52′ in FIG. 3D. Then the first substrate 530′ is completed.

FIG. 3E to 3F are schematic flow charts showing a process of manufacturing a second substrate 560. An electrode pattern 540 is fabricated on a substrate 54 in the FIG. 3E. In the FIG. 3F, a photo polymeric material mixture 56′ is coated on the substrate 54 and the electrode pattern 540. The photo polymeric material mixture 56′ is a solution comprised of colored and charged particles 53 and spacer 561. The manufacturing process for the second substrate 560 is illustrated in the following.

A step of manufacturing process for combining the first substrate 530′ and the second substrate 560 is illustrated in the FIG. 3G to FIG. 3J. Firstly, the first layer 530′ is placed in a reverse positioned on top of the second layer 560 as shown in FIG. 3G In the FIG. 3H, a mask 57 is disposed on top of the first substrate 530′ for enabling an ultra violet 5 exposure step. In the FIG. 3I, a plurality of polymer walls 58 are formed from combining the first substrate 530′ and the second substrate 560 after the ultra violet 5 exposure. The colored and charged particles are separated from the photo polymeric material. Consequentially, the polymeric material wraps the colored and charged particles 53. The solution, comprised of photo polymeric material and colored and charged particles 53, undergoes a phase separating process and a purified solvent 59 is formed. The first substrate 530′ and the second substrate 560 are removed from the assist substrate 50 and the buffer layer 51 in FIG. 3J. According to the second embodiment of the present invention, the manufacturing process for an electrophoretic display having single substrate and dual sides electrode is completed, wherein spacer controls thickness of display layer.

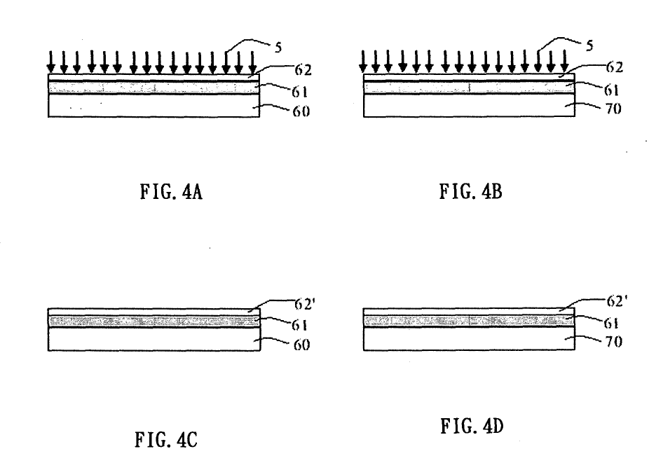

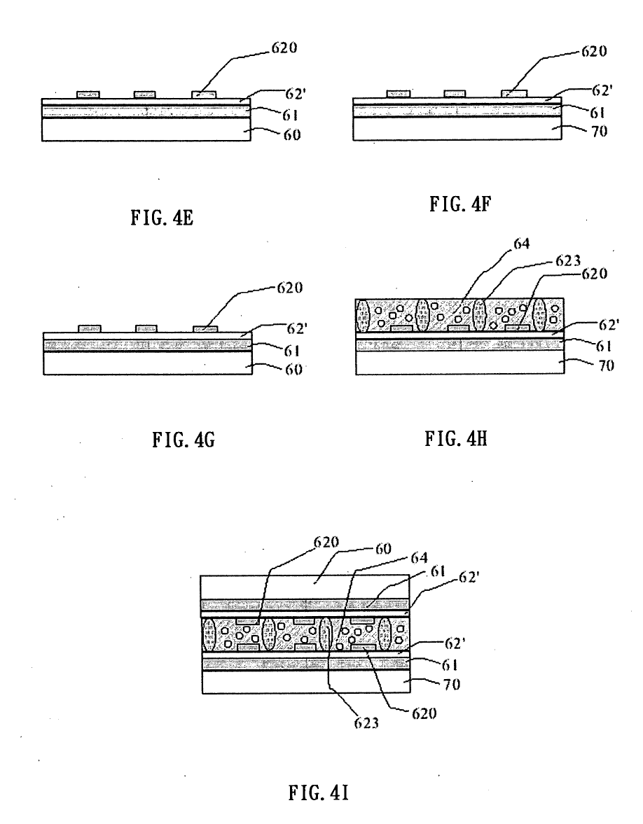

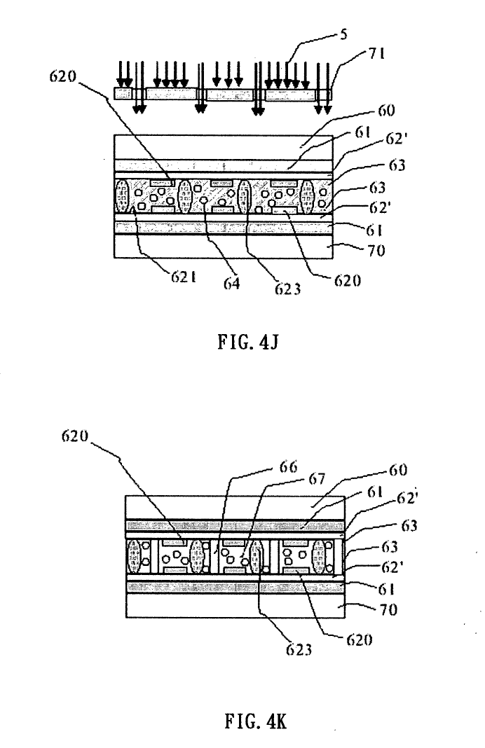

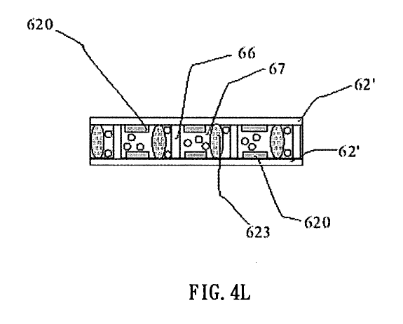

FIG. 4A to FIG. 4L are schematic views showing manufacturing process for a non substrate electrophoretic display according to the third embodiment of the present invention. Firstly, in the FIGS. 4A and 4B, a buffer layer 61 is fabricated on a first assist substrate 60 and a second assist substrate 70. The first assist substrate 60 and the second assist substrate 70 having the buffer layer 61 are coated with photo polymeric material 62. Then the first assist substrate 60 and a second assist substrate 70 are processed by an ultra violet 5 exposure. In the FIGS. 4C and 4D, photo polymeric material 62 becomes polymeric material hardened layer 62′. In the FIGS. 4D and 4F, an electrode pattern 620 is fabricated on the polymeric material hardened layer 62′. In the FIG. G, an electrode pattern 620 is formed on the first assist substrate 60 having the polymeric material hardened layer 62′. In the FIG. 4H, an electrode pattern 620 is formed on the second assist substrate having the polymeric material hardened layer 62′. The second assist substrate 70 having the polymeric material hardened layer 62′ and the electrode 620 is coated with the photo polymeric material mixture 64. The photo polymeric material mixture 64 is comprised of photo polymeric material, colored and charged particles and spacer 623. In the FIG. 41, the second assist substrate 70 is placed in a reverse positioned on top of the first substrate 60 and prepared for the exposure step after alignment. In the FIG. 4J, a mask 71 is placed on top of the first assist substrate 60 and the second assist substrate 70 for performing the ultra violet 5 exposure step. In the FIG. 4K, the photo polymeric material mixture 64 becomes a plurality of polymer walls after exposure. The plurality of polymer walls are combined with the first assist substrate 60 and the second assist substrate 70. The colored and charged particles are separated from the photo polymeric material. Consequentially, the polymeric material wraps the colored and charged particles 63. The photo polymeric material mixture 64 undergoes a phase separating process and forms a purified solvent 59. In the FIG. 4L, the buffer layer 61 is removed from the first assist substrate 60 and the second assist substrate 70. According to the third embodiment of the present invention, the manufacturing process for a non substrate electrophoretic display having dual sides electrode is completed.

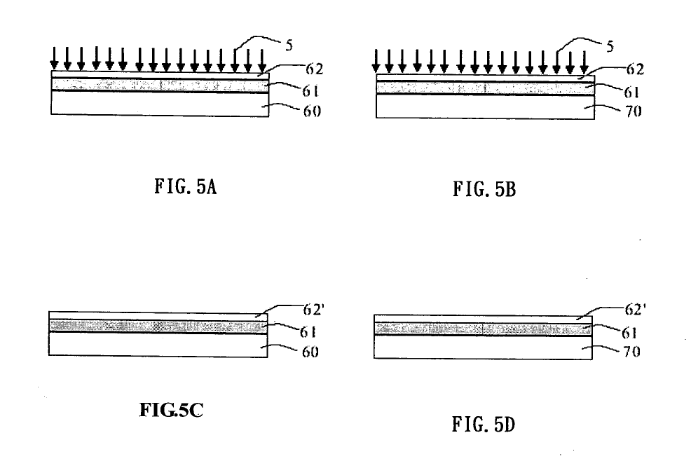

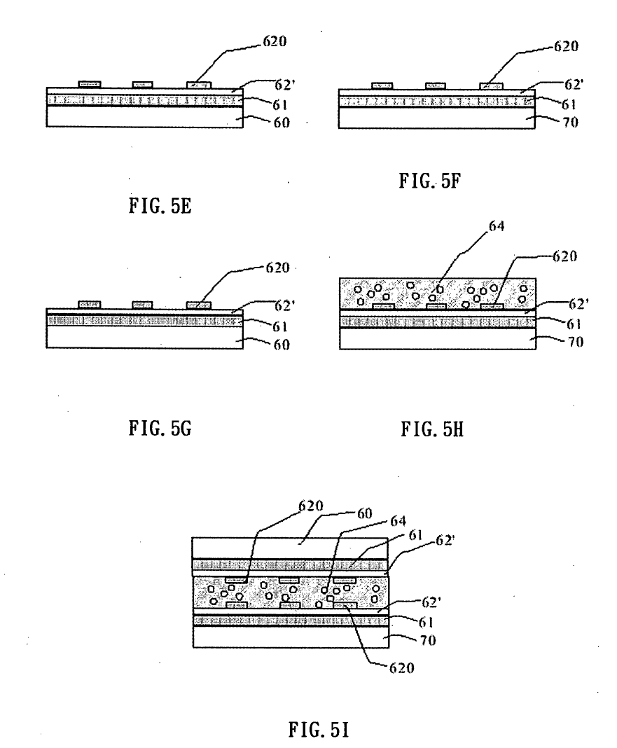

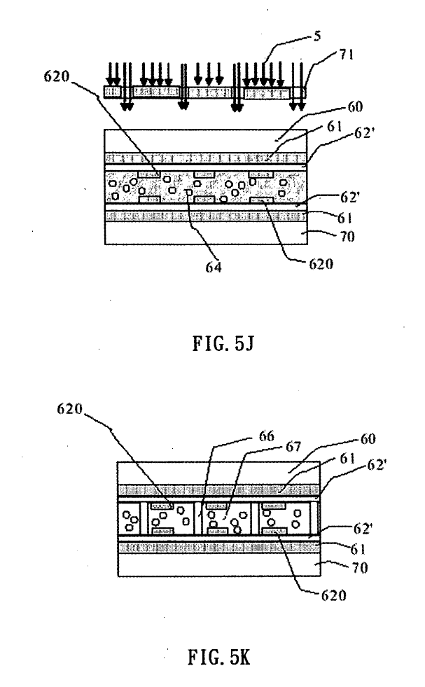

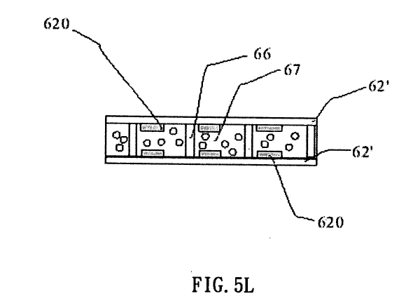

FIG. 5A to 5L are schematic views showing manufacturing process for a non substrate electrophoretic display according to the fourth embodiment of the present invention, The manufacturing process for the second embodiment is similar to the manufacturing process for the third embodiment. The major difference between two embodiments lines in fact that in the fourth embodiment, the photo polymeric material mixture is comprised of photo polymeric material and colored and charged particles.

Firstly, in the FIGS. 5A and 5B, a buffer layer 61 is fabricated on a first assist substrate 60 and a second assist substrate 70. The first assist substrate 60 and the second assist substrate 70 having the buffer layer 61 are coated with photo polymeric material 62. Then the first assist substrate 60 and a second assist substrate 70 are processed by an ultra violet 5 exposure. In the FIGS. 5C and 5D, photo polymeric material 62 becomes polymeric material hardened layer 62′ after exposure. In the FIGS. 5E and 5F, an electrode pattern 620 is fabricated on the polymeric material hardened layer 62′. In the FIG. 5G, an electrode pattern 620 is formed on the first assist substrate 60 having the polymeric material hardened layer 62′. An electrode pattern 620 is formed on the second assist substrate having the polymeric material hardened layer 62′ as shown in FIG. 5H. The second assist substrate 70 having the polymeric material hardened layer 62′ and the electrode 620 is coated with the photo polymeric material mixture 64. The photo polymeric material mixture 64 is comprised of photo polymeric material and colored and charged particles. In the FIG. 51, the first assist substrate 60 is placed in a reverse positioned on top of the second substrate 70 and prepared for the exposure step after alignment. In the FIG. 5J, a mask 71 is placed on top of the first assist substrate 60 and the second assist substrate 70 for performing the ultra violet 5 exposure step. In the FIG. 5K, the photo polymeric material mixture 64 becomes a plurality of polymer walls after exposure. The plurality of polymer walls are combined with the first assist substrate 60 and the second assist substrate 70. The colored and charged particles are separated from the photo polymeric material. Consequentially, the polymeric material wraps the colored and charged particles 63. The photo polymeric material mixture 64 undergoes a phase separating process and forms a purified solvent 59. In the FIG. 5L, The buffer layer 61 is removed from the first assist substrate 60 and the second assist substrate 70. According to the third embodiment of the present invention, the manufacturing process for a non substrate electrophoretic display having dual sides electrode is completed.

The colored and charged particles can be made of TiO₂ in the embodiments of manufacturing an electrophoretic display according to the present invention mentioned above. The display mode applicable is mainly reflective electrophoretic display. The operation modes include in-plane switching and non in-plane switching. Continuous roll to roll manufacturing process is applicable in the manufacturing process for an electrophoretic display. The electrodes counts contained in the pixels area can be singular or plural number.

The method for manufacturing an electrophoretic display is described comprehensively as above. The aforementioned manufacturing process is applicable in improving the manufacturing process for a single substrate liquid crystal display devised by Philips and is also applicable in manufacturing process for an electrophoretic display. Not only the yield rate is increased, also the diversity of the display modes is provided. In addition, the colored and charged particles are more easily wrapped and the thickness of the display layer material is uniformed.

The foregoing description of preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

What is claimed is:

1. A method for manufacturing an electrophoretic display comprising:
proceeding to a first substrate manufacturing process, including coating photo polymeric material on an assist substrate having a buffer layer and having the assist substrate being hardened by ultra violet exposure;
proceeding to a second substrate manufacturing process, including coating photo polymeric material mixture on a substrate having an electrode pattern;
proceeding to manufacturing process for combining the first substrate and the second substrate, including aligning the position of the assist substrate and the substrate, where the photo polymeric material layer is located between the assist substrate and the substrate, proceeding to mask exposure polymerization manufacturing process for combining the assist substrate and the substrate to form a plurality of polymer walls, separating colored and charged particles from the polymeric material, having the colored and charged particles being wrapped by the polymeric material, and then removing the assist substrate from the substrate.

2. The method for manufacturing an electrophoretic display of claim 1, wherein the photo polymeric material is photocurable resin.

3. The method for manufacturing an electrophoretic display of claim 1, wherein material of the assist substrate or the substrate is selected from a group consisting of glass, crystal, Teflon and plastic.

4. The method for manufacturing an electrophoretic display of claim 3, wherein the assist substrate or the substrate is further processed by a photo-absorbent layer or photo-reflective layer manufacturing process for enhancing display performance.

5. The method for manufacturing an electrophoretic display of claim 1, wherein material of the electrode pattern is a conductive membrane.

6. The method for manufacturing an electrophoretic display of claim 5, wherein the conductive membrane is made of ITO (Indium-Tin-Oxides) or PEDOT (polyethylene-dioxithiophene).

7. The method for manufacturing an electrophoretic display of claim 1, wherein materials of the buffer layer is selected from a group consisting of PE/PEWax, long-chain-fatty group, silicone and Teflon.

8. The method for manufacturing an electrophoretic display of claim 1, wherein a first substrate manufacturing process further comprises a step of fabricating an electrode patter on the assist substrate.

9. The method for manufacturing an electrophoretic display of claim 1, wherein the polymer walls formed by the photo polymeric material are closed matrix polymer walls.

10. The method for manufacturing an electrophoretic display of claim 1, wherein the polymer walls formed by the photo polymeric material are non-closed matrix polymer walls.

11. The method for manufacturing an electrophoretic display of claim 1, wherein the photo polymeric material mixture is comprised of photo polymeric material and colored and charged particles.

12. The method for manufacturing an electrophoretic display of claim 11, wherein the photo polymeric material mixture further comprises spacer.

13. A method for manufacturing an electrophoretic display comprising:
proceeding to a first substrate manufacturing process, including coating photo polymeric material on an assist substrate having a buffer layer, having the assist substrate being hardened by ultra violet exposure, then fabricating an electrode pattern on the assist substrate;
proceeding to a second substrate manufacturing process, including coating photo polymeric material on an assist substrate having a buffer layer, having the assist substrate being hardened by ultra violet exposure, fabricating an electrode pattern on the assist substrate after ultra violet exposure, and coating photo polymeric material mixture on the top of the assist substrate;
proceeding to manufacturing process for combining the first substrate and the second substrate, including aligning the position of two assist substrates, where the photo polymeric material layer is located between two assist substrates, proceeding to mask exposure polymerization manufacturing process for combining two assist substrates to form a plurality of polymer walls, separating colored and charged particles from the polymeric material, having the charged particles being wrapped by the polymeric material, and then removing one assist substrate from the other assist substrate.

14. The method for manufacturing an electrophoretic display of claim 13, wherein the photo polymeric material is photocurable resin.

15. The method for manufacturing an electrophoretic display of claim 13, wherein material of the assist substrate or the substrate is selected from a group consisting of glass, crystal, Teflon and plastic.

16. The method for manufacturing an electrophoretic display of claim 15, wherein the assist substrate or the substrate is further processed by a photo-absorbent layer or photo-reflective layer manufacturing process for enhancing display performance.

17. The method for manufacturing an electrophoretic display of claim 13, wherein material of the electrode pattern is a conductive membrane.

18. The method for manufacturing an electrophoretic display of claim 17, wherein the conductive membrane is made of ITO (Indium-Tin-Oxides) or PEDOT (polyethylene-dioxithiophene).

19. The method for manufacturing an electrophoretic display of claim 13, wherein materials of the buffer layer is selected from a group consisting of PE/PEWax, long-chain-fatty group, silicone and Teflon.

20. The method for manufacturing an electrophoretic display of claim 13, wherein a first substrate manufacturing process further comprises a step of fabricating an electrode pattern on the assist substrate.

21. The method for manufacturing an electrophoretic display of claim 13, wherein the polymer walls formed by the photo polymeric material are closed matrix polymer walls.

22. The method for manufacturing an electrophoretic display of claim 13, wherein the polymer walls formed by the photo polymeric material are non-closed matrix polymer walls.

23. The method for manufacturing an electrophoretic display of claim 13, wherein the photo polymeric material mixture is comprised of photo polymeric material and colored and charged particles.

24. The method for manufacturing an electrophoretic display of claim 23, wherein the photo polymeric material mixture further comprises spacer.
